(19) United States
(12) Patent Application Publication
(10) Pub. No.: US 2012/0197806 A1
(43) Pub. Date: Aug. 2, 2012

(54) SONIC BASED DIGITAL NETWORKING

(76) Inventor: Jason Lester Hill, Capistrano Beach, CA (US)

(21) Appl. No.: 13/363,049

(22) Filed: Jan. 31, 2012

Related U.S. Application Data
(60) Provisional application No. 61/438,055, filed on Jan. 31, 2011.

(51) Int. Cl. G06Q 20/40

(52) U.S. Cl. 705/67

(57) ABSTRACT

Systems, apparatuses and methods of using an acoustic communication mechanism to transmit data in the form of acoustic data from a mobile device to an electronic device are described. In one embodiment, a method of completing a purchase with a merchant using a mobile device starts with the mobile device sending a request message to a central server through a network interface. The mobile device then receives a token from the central server through the network interface that confirms that a payment in the purchase amount has been received at the merchant's account. This token is then translated into acoustic data and transmitted from the mobile device to an electronic device being associated with the identification of a merchant. Other embodiments are also described.

### CROSS-REFERENCE TO RELATED APPLICATIONS

This application is based upon and claims the benefit of priority from U.S. Provisional Application No. 61/438,055, filed on Jan. 31, 2011, the entire content of which are incorporated herein by reference.

### FIELD

Embodiments of the invention relate to the use of an acoustic communication mechanism to transmit data in the form of acoustic data from a mobile device to an electronic device are described. Other embodiments are also described.

### BACKGROUND

Modern wireless technology has brought wide area communication to nearly every square inch of the country. Data can be delivered at astonishing rates at the user's request to mobile communications devices (“mobile devices”) such as cell phones, personal digital assistants (PDAs), and pagers.

Currently, while it would be desirable and possible to extend wireless connectivity to everyday personal consumer electronics devices, the expensive monthly service contracts as well as the expensive electronics themselves would render such WiFi integration highly cost prohibitive.

Similarly, in the commercial setting, the merchants currently have to use expensive point of sale systems in order to be connected to the network.

### SUMMARY

Systems, apparatuses and methods using an acoustic communication mechanism to transmit data in the form of acoustic (sonic-based) data from a mobile device to an electronic device are described.

In one embodiment, a system includes an electronic device, a central server and a mobile device. The electronic device, which is associated with a merchant's identification, includes an acoustic receiver to receive acoustic data. The central server includes programmed processing circuitry that implements a payment processing module to coordinate a payment between a user's account and a merchant's account and a token generator to generate a token that confirms the payment being received at the merchant's account. The mobile device includes a communications network interface, a user interface, an acoustic transmitter, and programmed processing circuitry that implements a request module, a token receiver module and a translator module. The request module sends a request message that includes identification of the merchant and a purchase amount to the central server through the network interface. The token receiver module receives the token from the central server through the network interface and the translator module translates the token into the acoustic data. The acoustic transmitter then transmits the acoustic data to the electronic device.

In another embodiment, a method of completing a purchase with a merchant using a mobile device starts with the mobile device sending a request message to a central server through a network interface. The mobile device then receives a token from the central server through the network interface that confirms that a payment in the purchase amount has been received at the merchant's account. This token is then translated into acoustic data and transmitted from the mobile device to an electronic device being associated with the identification of a merchant.

In yet another embodiment, a system comprises an electronic device and a mobile device. The electronic device includes an acoustic receiver to receive acoustic data, a decoder, and a processor. The mobile device includes a communications network interface, a user interface to display a program associated with the electronic device and receive input from a user, an acoustic transmitter, and programmed processing circuitry that implements a control module and a translator module. The control module generates a digital program including the input from the user, and the translator module translates the digital program into the acoustic data. The acoustic transmitter then transmits the acoustic data to the electronic device. In this embodiment, once the electronic device receives the acoustic data, the decoder decodes the acoustic data to retrieve the digital program, and the processor executes the digital program.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 shows a block diagram of one embodiment a system using an acoustic communication mechanism to complete a purchase with a merchant using a mobile device.

FIG. 2 shows a flow diagram of one embodiment of a method to complete a purchase with a merchant using a mobile device.

FIG. 3 shows a block diagram of one embodiment of a system using an acoustic communication mechanism to transmit a digital program to an electronic device.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

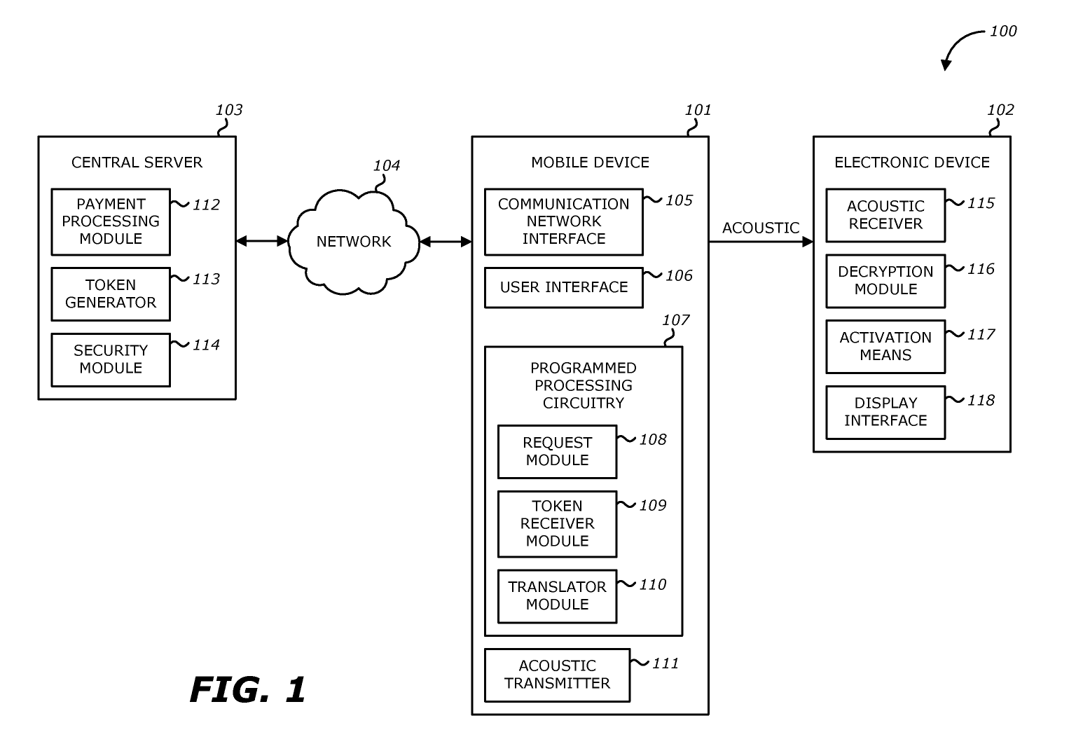

FIG. 1 shows a block diagram of one embodiment a system 100 using an acoustic communication mechanism to complete a purchase with a merchant using a mobile device. (See Table 1 for a list of non-limiting examples). The system 100 includes a mobile device 101, an electronic device 102, and a central server 103.

The mobile device 101 may be, for example, a pager, a personal digital assistant (PDA), or a portable voice communications device such as a cellular telephone and smart phone. The mobile device 101 includes a communication network interface 105, a user interface 106, a programmed processing circuitry 107, and an acoustic transmitter 111.

The mobile device 101 communicates with the central server 103 via a network 104 using the network interface 105. The network 104 may be an IEEE 802.11 data network (WiFi or Wireless Local Area Network, WLAN) or a cellular mobile phone network (e.g. a Global System for Mobile communications (GSM) network). The communication channel used to communicate between the mobile device 101 and the central server 103 may be a secure channel that uses a secure internet communication protocol such as HTTPS, SSH or SSL.

The user interface 106 may include input-output devices such as an audio receiver, a touch screen, a display screen, and a keyboard. In some embodiments, the user interface 106 of the mobile device 101 receives data inputs from the user. Such data inputs may include the identification of the merchant and the purchase amount. The user interface 106 of the mobile device 101 may display an application to the user to receive the merchant's identification as an input. The user may provide inputs to the mobile device 101 as tactile inputs via a keyboard or touch screen or as audio inputs via an audio receiver. The application may also contact a centralized web site (not illustrated) over the network 104 and provide the user with a web form that identifies the account of the purchaser (e.g., the user of the mobile device 101) and the account of the merchant. The user could then input the purchase amount into the application via the user interface 106. In some embodiments, the centralized web site may require that the user provide log-in information: username and password.

The centralized web site may also facilitate the user's use of the system 100 by storing and providing the identification information associated with a recurring merchant. The centralized web site may present the user with a list of the user's recurring merchants for selection. Similarly, in an access control setting or ticketing setting, the user may automatically be presented with the list of previously purchased tickets or the list of devices he is capable of operating/accessing. In one embodiment, a quick selection of the electronic device 102 that the user wishes to operate or the ticket he wishes to present would cause the digital token to be acoustically transmitted. In this embodiment, it is also contemplated that, the near-field communication of the acoustic communication may be used to verify the proximity of the transmission and multiple microphones or pick-ups may be used in order to perform three dimensional triangulation of the audio source.

The identification of the merchant is a data that is associated with the merchant. Such data may be the Web Uniform Resource Locator (URL) of the merchant's website, the merchant's email address, the merchant's phone number, the merchant's account number, a barcode that is linked to the merchant, and the merchant's mailing address. The barcode may be a traditional barcode or a two or three dimensional barcode. In some embodiments, the merchant's identification may be posted at the point of sale such that it could be manually inputted into the mobile device 101 by the user. In other embodiments, the mobile device 101 may automatically detect the merchant's identification using a global positioning system (GPS), optical analysis and/or infrared analysis.

As shown in FIG. 1, the programmed processing circuitry 107 implements a request module 108, a token receiver module 109, and a translator module 110.

The request module 108 may send a request message that includes the purchase amount and the identification of a merchant associated with the electronic device 102 to the central server 103 through the network interface 105. In some embodiments, the request message may further include at least one of: a requestor identification that identifies the user, an authorization duration, an authorization start time, an authorization end time, and an order summary. These elements of the request message may be appended with the digital signature prior to transmission from the mobile device 101 to the central server 103.

The token receiver module 109 receives tokens from the central server 103 through the network interface 105 and the translator module 110 translates the token into the acoustic data. The token may be a secure token that signifies that the purchase amount has been paid to the merchant. In some embodiments, the token includes at least one of: a requestor identification that identifies the user, the identification of the merchant, a transaction identification, a time stamp, the purchase amount, and a digital signature. In the example where the token includes the identification of the merchant, the user may redeem the purchase associated with the token at any location that is associated with the identification of the merchant. This system 100 could also be used to facilitate anonymous transactions. The user could request a token that does not explicitly include a requestor identification that identifies the user.

The acoustic transmitter 111 receives the acoustic data from the translator module 110 and transmits the acoustic data to the electronic device 102 over an acoustic channel. The acoustic transmitter 111 may also broadcast the acoustic data to be detected by the appropriate electronic device 102. In some embodiments, the mobile device 101 may include a simple digital-to-analog converter in the translator module 110 connected to a basic speaker included in the acoustic transmitter 111 in order to generate the audio tone. The digital-to-analog converter and the basic speaker may be the same circuit used in the ear piece and speaker of a mobile telephone circuit.

The acoustic data may take any number of forms. In one simple embodiment, the acoustic data may be in the form of DTMF tones which is the encoding scheme used in traditional telephone systems and based around the detection and transmission of specific frequencies. Other forms of acoustic data include pulse-based encoding schemes, audio frequency shift keying, and phase shift keying. For moderate to low data rates, encoding schemes such as V.21, V.22 or V.22bis. These protocols are particularly well suited for low cost receivers.

It is also contemplated that forward error correction may be employed in order to increase the reliability of the transmission; “mapping by set partitions” may be used to increase the data rate without increasing the error rate; error correcting codes and CRC error detection codes may be used for error checking; and digital compression may be used when the digital tokens as sizeable.

Similar to the mobile device 101, the electronic device 102 in FIG. 1 may be equipped with a portable power source or battery that would allow it to operate without any external connections. The electronic device 102 is associated with the merchant and the merchant's identification. The electronic device 102 may be, for example, a simplified point of sale system that does not need to be connected to the network 104. Instead, the electronic device 102 includes an acoustic receiver 105 to receive the acoustic data from the mobile device 101. The acoustic receiver 115 may also include a low-power microphone and an analog-to-digital converter connected to a signal processor.

In other embodiments, the acoustic receiver 115 further includes a detection circuitry that detects elements of the acoustic data such as amplitude, phase shifts and other acoustic phenomena. The detection circuitry may be a digital signal processor that analyzes the incoming sound to detect the digital message (e.g., token). The digital signal processor may also be a typical modem demodulator.

The acoustic receiver 115 may further include circuitry that detects when the acoustic data is ready to be received. This circuitry may include: a push-button, a Piezo-Electric pressure sensor, a tilt sensor, shock sensor, acceleration sensor, micro switch, toggle, acoustic sensor, capacitive touch sensor, key press sensor, light level sensor, motion detector, touch screen, vibration sensor, any other electromagnet transducer or be actuated by software.

As illustrated in FIG. 1, the electronic device 102 may include a decryption module 116, activation means 117 and a display interface 118.

The decryption module 116 decrypts the acoustic data received from the mobile device 101 and confirms authenticity of the acoustic data. The decryption module 116 thus determines that the merchant has indeed been paid an appropriate amount and the display interface 118 provides a display that confirms to the merchant that the payment is received. The display interface 118 is a user display interface such as a simple LED indicator or a complex multi-color LCD display.

The authenticity of the acoustic data can be determined using a variety of cryptographic procedures including, but not limited to, RSA, DSA, DES, BlowFish, MD5, TwoFish, elliptic curve etc. . . . In one embodiment, acoustic data is determined to originate from the central server 103 when the token associated with the acoustic data is cryptographically signed using a public key. A digital signature that is associated with the central server 103 is attached to each token that originates therefrom. This signature may be verified by electronic device 102 that has been pre-programmed with the public key of the central server 103. In an alternate embodiments, the tokens can be signed with a shared secret key that is pre-assigned by the central server 103 to the electronic device 102. In other embodiments, a combination of cryptographic procedures may be used such that multiple signatures are attached to a single token.

When the acoustic data is confirmed to be authentic by the decryption module 116, the activation means 117 is activated. Activation means 117 may include, for example, an electrical output signal, a mechanical latch, an acoustic transducer, a digital output, an analog output, an electrical motor, a stepper motor, door lock, a solenoid, IR transmitter, and RF transmitter, a relay, a light source, a network output, telephone communication device, a digital paging transmitter, a cellular based device or any other form of electrical transducer. In one example, the electronic device 102 may be an automated point of sale such as a vending machine. Accordingly, upon authentication of an acoustic data, the vending machine may activate an electrical output that is connected to the main processing board of the vending machine in order to signal that money has been received. This electrical output may take the form of a signal on an SPI bus that communicates the actual amount received. Further, the vending machine may dispense the purchased product via activation of a mechanical latch. In another example, the electronic device 102 is a parking meter. Upon authentication of an acoustic data, the parking meter may authorize the parking service via activation of a digital output. In yet another example, the electronic device 102 is a car's central computer which, upon authentication of the acoustic data, may generate a transmission on a CAN bus that would transmit a signal to the car's central computer and cause the central computer to lock or unlock the doors of the car or start the engine.

For transactions of a small amount of money, the creation of a secure token alone may be sufficient to signify that the transfer of money is complete. However, in some embodiments, for larger amounts, the electronic device 102 may have to accept and record the token and present it later to the central server 103 for payment. Additional security steps could also be added such as requiring extra PIN, dialog, explicit entry of secure information, etc. . . .

Referring to FIG. 1, the central server 103 that communicates with the mobile device 101 via the network 104 is a trusted source. In some embodiments, the central server 103 is the central trusted authority. In other embodiments, the central server 103 may be a secondary authority that may be used for domain specific authorization. As shown in FIG. 1, the central server 103 includes programmed processing circuitry that implements a payment processing module 112 to coordinate a payment between a user's account and a merchant's account, and a token generator 113 to generate a token that confirms that the payment is received at the merchant's account. For example, in order to utilize the mobile device 101 such as a cellular phone to authorize a payment of twenty dollars, a user could request and receive a twenty dollar credit authorization from the central server 103 in a digital form (e.g., the token) over the network 104 and then deliver that secure credit (e.g., acoustic data) over an audio communication channel to the merchant's electronic device 102. In this embodiment, the merchant may receive cash or a direct credit from the central server 103 either when the token is issued to the mobile device 101 or when the acoustic data is authenticated. In other embodiments, a central server 103 may automatically be linked to traditional payment options such as bank transfers, credit card charges, money order, or other billing and payment systems.

In some embodiments, the central server 103 includes programmed processing circuitry that further implements a security module 114 that generates a digital signature and includes the digital signature in the token. As discussed above, the tokens may be encoded with cryptographic techniques to simplify the verification process on the end device. Additionally, the tokens may include sequencing information to ensure that replay attacks cannot be used in the system 100. For example, each token to a merchant may include a sequence number that is stored by the electronic device 102 once the token associated with the acoustic data is received. Based on the sequence numbers stored therein, the electronic device 102 may determine if a token has previously been redeemed. In other embodiment, if a new token was received that had a sequence number that is out of order or that had already been received, the electronic device 102 may also conclude that either a token was lost or a customer was attempting to re-present the same token. In some embodiments, the tokens may include a time stamp to ensure that they are delivered expeditiously. In other words, the tokens may expire if not presented to an electronic device 102 within in a time frame set forth in the token.

One advantage to the system 100 is that the merchant not requiring an expensive point of sale system or terminal that is connected to a network 104. Instead, the merchant simply requires a low-cost acoustic receiver 115 that can decode the acoustic data.

Another advantage of system 100 is that the ability to generate audio tones (e.g., acoustic data) is already inherent in most modern mobile devices such that no additional infrastructure is required. Exploiting audio-based communications as the last link in the wide area network communication chain solves near field disambiguation and interoperability issues that have been faced by short-range RF technologies. This also makes acoustic-based communication ideal for secure point of sale transactions.

It is also contemplated that if the mobile device 101 is an older generation cellular phone, the transmission of the authorization tokens between the mobile device 101 and the electronic device 102 may also be done by using a multimedia text message or via the voice communication channel directly.

TABLE 1
Non-limiting examples of system 100

| | |
|---|---|
| Facilitating | Authorize entry into theme parks, movie |
| payments for | theatres, transit systems, secure areas |
| product and | Make payments to parking meters |
| services; | Select products for a vending machine |
| Facilitating | to dispense and track what has been |
| transfer of | dispensed |
| information | Make payment to vending machine |
| | Authorize movie rental |
| | Authorize equipment rental and |
| | communicate rental contract information |
| | Purchase any Service or Product |
| | Accept payments or orders at a Food |
| | Stand |
| | Accept payments or orders at a |
| | Restaurant |
| | Authorize a Gasoline Purchase |
| | Authorize a Carwash |
| | Confirm a credit card payment to |
| | merchant |
| | Authorize a Pay-Per-View purchase |
| | Issue public transportation ticket |
| | Make Taxi Payments |
| | Operate a Laundromat |
| | Transfer a secure authorization |
| | Transfer security token into any |
| | consumer products |
| | Transfer a secret, shared, public or |
| | private cryptography key |
| | Transfer boarding pass information |
| | Authorization or authentication of a |
| | device |
| | Place an purchase order or pre-order |
| | Place an order for Movie tickets |
| | Place an order for Travel tickets |
| | Order from an on-line offerings |
| | description and receive a token for |
| | that product |
| | To implement a digital cash or a |
| | digital check system |
| | Enhancing the security around |
| | individual credit card transaction |
| | Pay toll |
| | Buy postage |
| | Create a digital key system for Cars, |
| | Buildings, Rooms, Storage or other |
| | objects |

The following embodiments of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, etc.

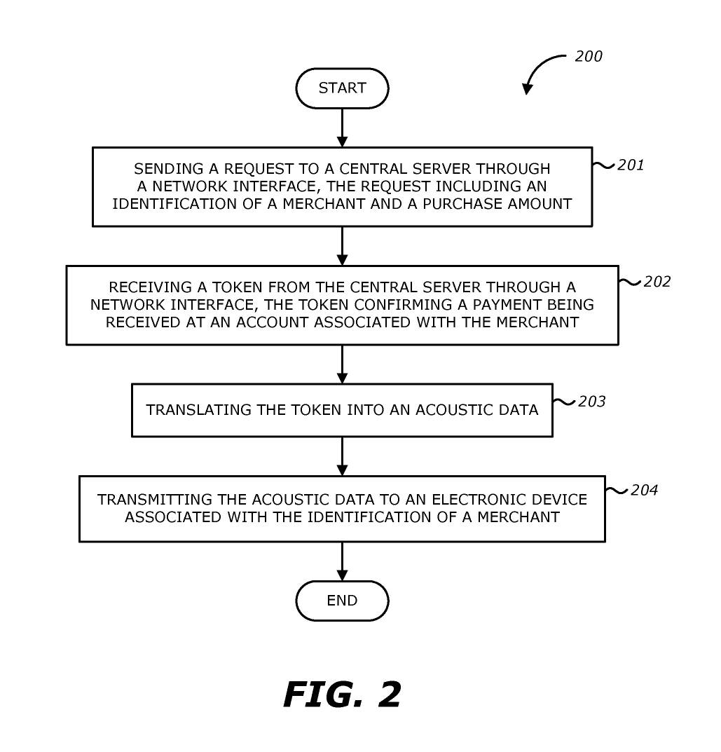

FIG. 2 shows a flow diagram of one embodiment of a method 200 to complete a purchase with a merchant using a mobile device.

As shown in FIG. 2, the method starts with the mobile device sending a request message to the central server through a network interface of the mobile, at Block 201. The request message includes at least an identification of a merchant and a purchase amount. At Block 202, the mobile device receives a token from the central server through the network interface. The token confirms a payment in the purchase amount has been received at an account associated with the merchant. At Block 203, the mobile device translates the token into acoustic data, and at Block 204, the acoustic data is transmitted to an electronic device being associated with the identification of a merchant.

In some embodiments, the acoustic data is decrypted by the electronic device, which then confirms authenticity of the acoustic data to complete the purchase.

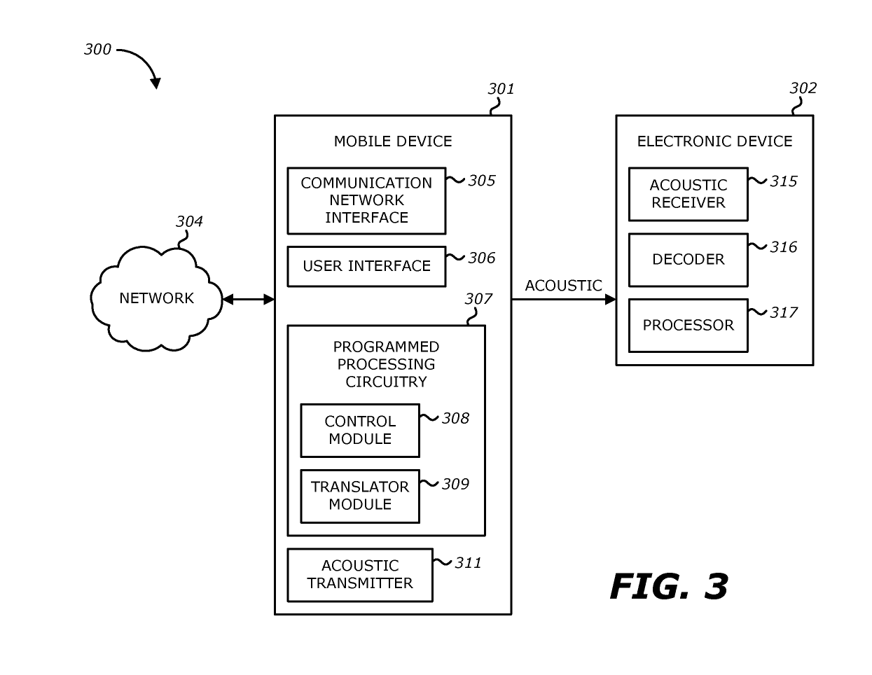

FIG. 3 shows a block diagram of one embodiment of a system 300 using an acoustic communication mechanism to provide a digital program to an electronic device 302. The system 300 includes a mobile device 301 and an electronic device 302.

The electronic device 302 may be any home consumer electronics device such as, for instance, a coffee maker or a garage door access device. However, it is also contemplated that other electronic devices 302 may be used (See Table 2 for a list of non-limiting examples).

TABLE 2
Non-limiting examples of system 300

| | |
|---|---|
| Access | Authorize entry through a gate or |
| Authorization | doorway |
| or | Authorize access to a lock-box |
| Authentication | Facilitate Parking Garage Entry and |
| | exit |
| | Facilitate Home Entry |
| | Provide communication of identity |
| | information |
| | Perform personnel authentication |
| Programming | Program Remote Control/Access to doors |
| electronics | Automate security Systems and access |
| devices | control |
| | Program and control a lighting control |
| | system |
| | Program an electric timer |
| | Program digital devices such as alarm |
| | clocks and remote controls |
| | Program and operate car locks, |
| | electronic locks |
| | Program and operate lighting system, an |
| | entertainment system, entertainment |
| | system component, HVAC system, |
| | sprinklers system, telephone system, |
| | home appliances, a GPS system or car |
| | navigation system |
| | Program or operate a car functions |
| | Communicate a TV control request |
| | Program or operate a toy |
| | Program a TV remote |
| | Program a Home automation system |
| | Set a time keeping device or watch |
| | Program a network router |
| Facilitating | Facilitate the digital transfer of |
| information | information |
| transfer | Facilitate reading and reporting of |
| | electric or other utility meter |
| | Facilitate meter reading by providing a |
| | temporary secure wide-area link to |
| | meter or valve |
| | Report diagnostic information about a |
| | problem |
| | Bootstrap any secure communication |
| | protocol |
| | Transfer a secret, shared, public or |
| | private cryptography key |

As illustrated in FIG. 3, the electronic device 302 may include an acoustic receiver 315 to receive acoustic data, a decoder 316, and a processor 317.

The mobile device 301 may include a communications network interface 305 through which the mobile device 301 may download a program associated with the electronic device 302 from a network 304. As shown in FIG. 3, the mobile device 301 may also include a user interface 306 to display the program and receive input from a user. For example, a program associated with a coffee maker may be downloaded onto the mobile device 301 and using this program, the user may input the desired settings including the current clock time, the desired brewing time, the desired coffee strength etc.

The mobile device 301 may also include a programmed processing circuitry 307 that implements a control module 308 and a translator module 309. The control module 308 generates a digital program including the input from the user. In the previous example, the digital program comprising executable instructions that include the desired settings inputted by the user (e.g., current clock time, brewing time, coffee strength). The translator module 309 then translates the digital program into the acoustic data. As shown in FIG. 3, the mobile device 301 also includes an acoustic transmitter 311 to transmit the acoustic data to the electronic device 302.

In this embodiment, once the acoustic receiver 315 included in the electronic device 302 receives the acoustic data, the decoder 316 decodes the acoustic data to obtain the digital program and the processor 317 executes the digital program. In some embodiments, executing the digital program may include programming a function of the electronic device 302. For instance, using the previous example of the coffee maker, the digital program that comprises instructions that include the desired settings is translated into acoustic data by the mobile device 301 and transmitted to the coffee maker. The coffee maker's acoustic receiver 315 may receive the acoustic data, its decoder 316 may decode the acoustic data to obtain the digital program with the desired settings, and its processor 317 may execute the digital program such that the desired settings are implemented by the coffee maker.

In another embodiment, the electronic device 302 is an access device such as a garage door access device. In this embodiment, the mobile device 301 may display the downloaded program associated with the garage door access device and receive inputs from the user that is used to authenticate the user as having valid access to the garage door access device. The mobile device 301 may then generate a digital program including the inputs used to authenticate the user. The digital program is subsequently translated into acoustic data and transmitted to the garage door access device. In this embodiment, after the decoder 316 decodes the acoustic data to obtain the digital program, the processor 317 executes the digital program which includes authenticating the user to activate the garage door access device and provide entry to the user.

Similarly to system 100, the advantages of the system 300 include that the electronic device 302 does not need to connected to a network 304 and the mobile device 301 already has the ability to generate acoustic data. Further, another advantage of this system 300 is that the user interface 106 of the mobile device 101 may greatly enhance the interfaces of the everyday consumer electronics.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

All or part of an embodiment may be implemented by various means depending on applications according to particular features, functions. These means may include hardware, software, or firmware, or any combination thereof. A hardware, software, or firmware element may have several modules coupled to one another. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A system comprising:
an electronic device including an acoustic receiver to receive acoustic data, the electronic device being associated with an identification of a merchant;
a central server including programmed processing circuitry that implements
a payment processing module to coordinate a payment between a user's account and a merchant's account, the merchant's account being associated with the identification of the merchant, and
a token generator to generate a token that confirms the payment being received at the merchant's account; and
a mobile device including
a communications network interface,
a user interface,
programmed processing circuitry that implements
a request module to send a request message to the central server through the network interface, the request message including the identification of the merchant and a purchase amount,
a token receiver module to receive the token from the central server through the network interface, and
a translator module to translate the token into the acoustic data, and
an acoustic transmitter to transmit the acoustic data to the electronic device.

2. The system of claim 1, wherein the request message further includes at least one of: a requestor identification that identifies the user, an authorization duration, an authorization start time, an authorization end time, and an order summary.

3. The system of claim 1, wherein the token includes at least one of: a requestor identification that identifies the user, the identification of the merchant, a transaction identification, a time stamp, the purchase amount, and a digital signature.

4. The system of claim 1, wherein the user interface of the mobile device to receive the identification of the merchant and the purchase amount inputted by the user.

5. The system of claim 1, wherein the identification of the merchant is at least one of: a Web Uniform Resource Locator (URL), an email address, a phone number, an account number, a barcode, and an address of the merchant.

6. The system of claim 1, wherein the identification of the merchant obtained using at least one of: a global positioning system (GPS), optical analysis and infrared analysis.

7. The system of claim 1, wherein the electronic device further includes a decryption module to decrypt the acoustic data and to confirm authenticity of the acoustic data.

8. The system of claim 7, wherein the electronic device further includes an activation means that is activated when the acoustic data is confirmed to be authentic.

9. The system of claim 1, wherein the programmed processing circuitry included in the central server further implements:
a security module that generates a digital signature and includes the digital signature in the token.

10. The system of claim 1, wherein the acoustic receiver included in the electronic device further includes a detection circuitry to detect elements of the acoustic data, the elements including at least one of amplitude, phase shifts and other acoustic phenomena.

11. The system of claim 1, wherein the electronic device further includes a display interface to provide a display that confirms the payment being received.

12. A method of completing a purchase with a merchant using a mobile device, the method comprising:
sending a request message from the mobile device to a central server through a network interface, the request message including an identification of a merchant and a purchase amount;
receiving a token by the mobile device from the central server through the network interface, the token confirming a payment in the purchase amount being received at an account associated with the merchant;
translating the token into an acoustic data; and
transmitting the acoustic data from the mobile device to an electronic device being associated with the identification of a merchant.

13. The method of claim 12, further comprising: decrypting by the electronic device the acoustic data and confirming authenticity of the acoustic data by the electronic device to complete the purchase.

14. The method of claim 12, wherein the request message further includes at least one of: a requestor identification that identifies the user, an authorization duration, an authorization start time, an authorization end time, and an order summary.

15. The method of claim 12, wherein the token includes at least one of: a requestor identification that identifies the user, the identification of the merchant, a transaction identification, a time stamp, the purchase amount, and a digital signature.

16. The method of claim 12, further comprising: receiving at a user interface of the mobile device the identification of the merchant and the purchase amount inputted by the user.

17. The method of claim 12, wherein the identification of the merchant is at least one of: a Web Uniform Resource Locator (URL), an email address, a phone number, an account number, a barcode, and an address of the merchant.

18. The method of claim 12, further comprising: obtaining the identification of the merchant using at least one of: a global positioning system (GPS), optical analysis and infrared analysis.

19. A system comprising:
an electronic device including
an acoustic receiver to receive acoustic data,
a decoder, and
a processor; and
a mobile device including
a communications network interface,
a user interface to display a program associated with the electronic device and receive input from a user,
programmed processing circuitry that implements
a control module to generate a digital program including the input from the user, and
a translator module to translate the digital program into the acoustic data, and
an acoustic transmitter to transmit the acoustic data to the electronic device,
wherein the decoder included in the electronic device decodes the acoustic data to retrieve the digital program, and the processor included in the electronic device executes the digital program.

20. The system of claim 19, wherein the mobile device downloads the program associated with the electronic device though the network interface.

21. The system of claim 19, wherein the electronic device is an access device, and wherein executing the digital program includes authenticating the user to activate the access device and provide entry to the user.

22. The system of claim 19, wherein executing the digital program includes programming a function of the electronic device.
